(19) United States
(12) Patent Application Publication
(10) Pub. No.: US 2018/0111266 A1
(43) Pub. Date: Apr. 26, 2018

(54) CONTROL DEVICE, ROBOT, AND ROBOT SYSTEM

(71) Applicant: Seiko Epson Corporation, Tokyo (JP)

(72) Inventors: Ryuichi OKADA, Matsumoto (JP); Fumiaki HASEGAWA, Azumino (JP)

(21) Appl. No.: 15/783,200

(22) Filed: Oct. 13, 2017

(30) Foreign Application Priority Data
Oct. 20, 2016 (JP) 2016-205739
Jul. 31, 2017 (JP) 2017-148235

(51) Int. Cl. B25J 9/16; B25J 13/08

(52) U.S. Cl. CPC B25J 9/1633; B25J 9/1682; B25J 13/085; B25J 9/161

(57) ABSTRACT

A control device for controlling driving of a robot having a force detection unit includes a processor which, when causing the robot to carry out work a plurality of times, performs force control on the robot based on an output from the force detection unit and teaches the robot a first position, in a first round of the work, and which, in a second round of the work, performs position control on the robot based on first position data about the first position acquired in the first round of the work and causes a predetermined site of the robot to move to the first position.

### BACKGROUND

### 1. Technical Field

The present invention relates to a control device, a robot, and a robot system.

### 2. Related Art

Traditionally, an industrial robot having a robot arm and an end effector which is attached to the distal end of the robot arm and carries out work on a target object is known.

As such a robot, for example, JP-A-2015-182165 discloses a robot having a robot arm, an end effector, a force sensor provided on the robot arm, and a control unit which controls driving of the robot arm. In the robot disclosed in JP-A-2015-182165, in order to carry out work with high accuracy in which the end effector comes in contact with a target object or the like, the control unit performs force control to control driving of the robot arm, based on the result of detection from the force sensor.

However, generally, in the force control based on the result of detection from the force sensor, due to insufficient responsiveness or control cycle of the force sensor, repetitive stability of positioning by the force control may not be achieved depending on the work unless the operating speed of the robot arm is slowed down below its normal speed. Therefore, the operating speed of the robot arm needs to be slowed down. This causes a problem that improving productivity is difficult.

### SUMMARY

An advantage of some aspects of the invention is to solve at least one of the problems described above, and the invention can be implemented as the following configurations.

A control device according to an aspect of the invention is a control device for controlling driving of a robot having a force detection unit and includes a control unit which, when causing the robot to carry out work a plurality of times, performs force control on the robot based on an output from the force detection unit and teaches the robot a first position, in a first round of the work, and which, in a second round of the work, performs position control on the robot based on first position data about the first position acquired in the first round of the work and causes a predetermined site of the robot to move to the first position.

With the control device according to the aspect of the invention, in the first round of work, accurate positioning can be realized, and in the second round of work, positioning control can be carried out based on the first position data acquired in the first round of work. Therefore, in the second round of work, the operating speed (movement speed of the predetermined site) can be made faster than in the first round while accurate positioning is realized. Thus, for example, a number of high-quality products can be produced stably and productivity can be increased.

The term “force detection unit” refers to a unit which detects, for example, a force (including a moment) applied to a robot, that is, an external force, and outputs a result of detection (force output value) corresponding to the external force. For example, the “force detection unit” can be configured of a force sensor, a torque sensor or the like.

In the control device according to the aspect of the invention, it is preferable that the control unit, in the second and subsequent rounds of the work, performs position control on the robot based on the first position data and causes the predetermined site of the robot to move to the first position.

With this configuration, in the second and subsequent rounds of work, the operating speed can be made faster than in the first round of work while the predetermined site is properly positioned at the first position. Therefore, productivity can be increased further.

The term “second and subsequent rounds of work” is not limited to meaning all of the second and subsequent rounds of work but also means work in an arbitrary number of rounds from the second round.

In the control device according to the aspect of the invention, it is preferable that the control unit, in the first round of the work, performs force control on the robot based on an output from the force detection unit and teaches the robot the first position and a second position that is different from the first position, and that the control unit, in the second round of the work, performs processing in which position control is performed on the robot based on the first position data, thus causing the predetermined site to be situated at the first position, and processing in which position control to control the robot based on second position data about the second position acquired in the first round of the work and force control to control the robot based on an output from the force detection unit are performed, thus driving the robot and causing the predetermined site to be situated at the second position.

In this way, in the second round of work, position control can be performed in the processing on the first position, and both of force control and position control can be performed in the processing on the second position. Therefore, for example, by using position control only or both of force control and position control according to the processing content or the like, it is possible to cause the robot to carry out work more accurately and quickly with respect to one type of work.

In the control device according to the aspect of the invention, it is preferable that the control unit can detect an abnormality of the robot and detects an abnormality of the robot based on an output from the force detection unit while performing the position control.

With this configuration, if an abnormality is detected, for example, the driving of the robot can be stopped or the first round of work can be redone. Therefore, a number of high-quality products can be produced more stably.

In the control device according to the aspect of the invention, it is preferable that the control unit, in a predetermined round of the work, performs force control on the robot based on an output from the force detection unit and causes the predetermined site to move to the first position.

In this way, by moving the predetermined site to the first position by force control in a predetermined round other than the first round, it is possible to confirm whether accurate positioning is realized or not and to correct the first position data according to need, in the predetermined round.

In the control device according to the aspect of the invention, it is preferable that the robot has a plurality of robot arms and that the force detection unit is provided on at least one of the plurality of robot arms.

Generally, in a robot having a plurality of robot arms, the arm width of the robot arms is relatively narrow. Therefore, the robot arms tend to lack rigidity, making it difficult to perform accurate positioning. However, the control device according to the above aspect enables an increase in productivity even with such a robot.

A robot according to an aspect of the invention includes a force detection unit and carries out work a plurality of times. The robot is controlled by the control device according to the foregoing aspect.

With the robot according to the aspect of the invention, under the control of the control device, cycle time can be reduced while accurate positioning is realized. Thus, productivity can be increased.

A robot system according to an aspect of the invention includes the control device according to the aspect of the invention, and a robot which is controlled by the control device and has a force detection unit.

With the robot system according to the aspect of the invention, under the control of the control device, cycle time can be reduced while accurate positioning is realized. Thus, productivity can be increased.

### BRIEF DESCRIPTION OF THE DRAWINGS

The invention will be described with reference to the accompanying drawings, wherein like numbers reference like elements.

FIG. 1 is a perspective view of a robot system according to a preferred embodiment of the invention.

FIG. 2 is a schematic view of a robot shown in FIG. 1.

FIG. 3 shows an end effector and a force detection unit of the robot shown in FIG. 1.

FIG. 4 shows the system configuration of the robot system shown in FIG. 1.

FIG. 5 shows an example of a workbench where the robot shown in FIG. 1 carries out work.

FIG. 6 shows the state where a case is loaded on an assembly table shown in FIG. 5.

FIG. 7 shows the state where a lid member is loaded on the case on the assembly table shown in FIG. 5.

FIG. 8 shows a target trajectory A1 of the distal end of one robot arm.

FIG. 9 shows a target trajectory A2 of the distal end of the other robot arm.

FIG. 10 is a flowchart showing an example of work flow.

FIG. 11 is a flowchart showing first control shown in FIG. 10.

FIG. 12 shows the state where the distal end of one end effector is situated at a taught point P11.

FIG. 13 shows the state where the distal end of the one end effector is situated at a corrected taught point P110.

FIG. 14 shows the state where the distal end of the one end effector is situated at a taught point P12.

FIG. 15 shows the state where the distal end of the one end effector is situated at a corrected taught point P120.

FIG. 16 shows the state where the distal end of the other end effector is situated at a taught point P21.

FIG. 17 shows the state where the distal end of the other end effector is situated at a corrected taught point P210.

FIG. 18 shows the state where the distal end of the other end effector is situated at a taught point P22.

FIG. 19 shows the state where the distal end of the other end effector is situated at a corrected taught point P220.

FIG. 20 shows a target trajectory A10 obtained by correcting the target trajectory A1 shown in FIG. 8.

FIG. 21 shows a target trajectory A20 obtained by correcting the target trajectory A2 shown in FIG. 9.

FIG. 22 is a flowchart showing second control shown in FIG. 10.

FIG. 23 shows the state where the distal end of an end effector is situated at a corrected taught point P310.

FIG. 24 shows the state where the distal end of the end effector is situated at a corrected taught point P320.

FIG. 25 is a perspective view schematically showing the state where the case is gripped by the end effector.

### DESCRIPTION OF EXEMPLARY EMBODIMENTS

Hereinafter, a control device, a robot and a robot system according to the invention will be described in detail, referring to a preferred embodiment shown in the accompanying drawings.

### Robot System

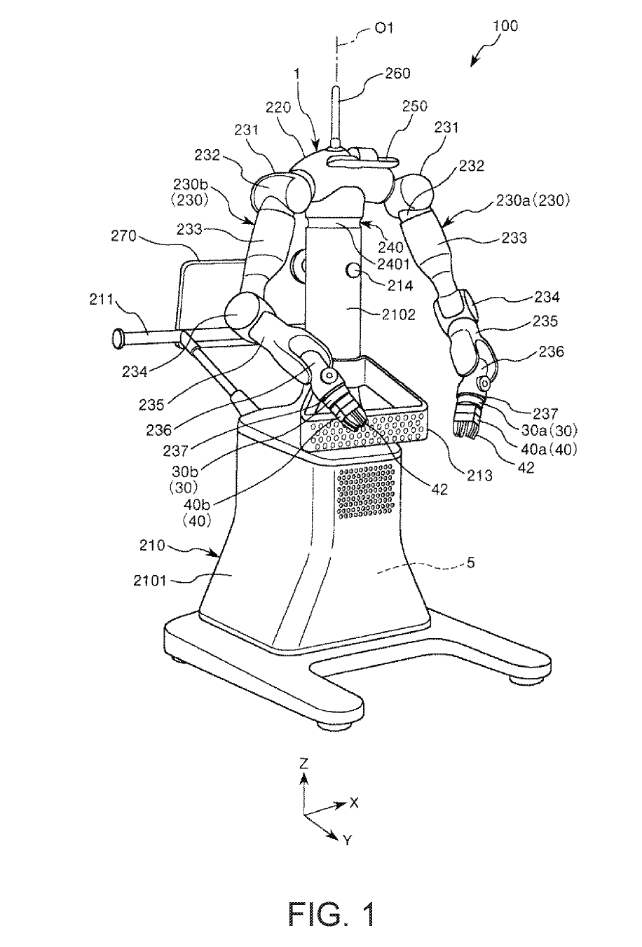

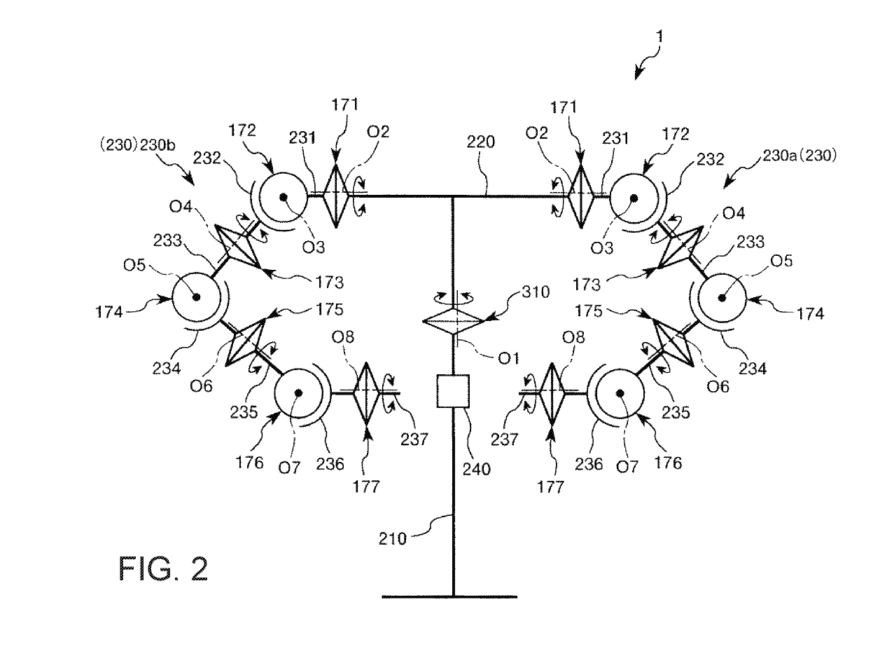

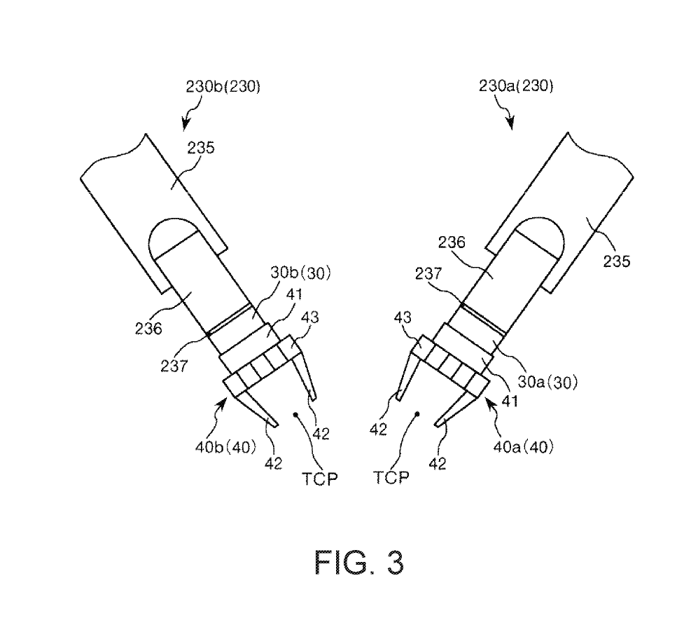

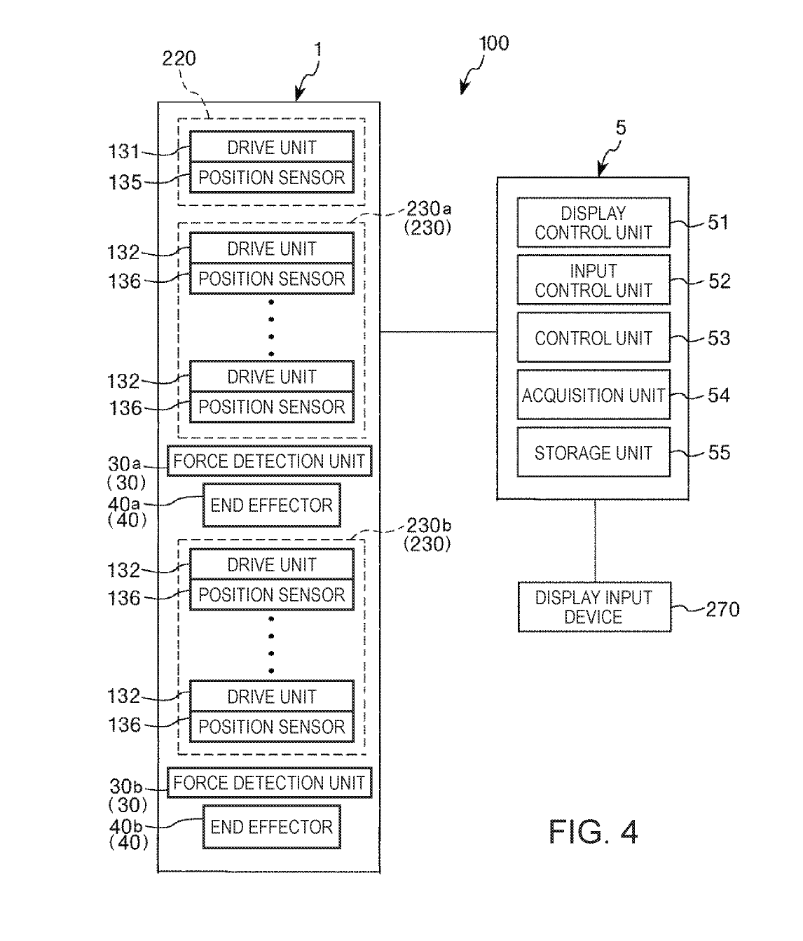

FIG. 1 is a perspective view of a robot system according to a preferred embodiment of the invention. FIG. 2 is a schematic view of a robot shown in FIG. 1. FIG. 3 shows an end effector and a force detection unit of the robot shown in FIG. 1. FIG. 4 shows the system configuration of the robot system shown in FIG. 1. In the description below, for the sake of convenience of the description, the upper side in FIG. 1 is referred to as “top” and the lower side is referred to as “bottom”. The base side in FIG. 1 is referred to as “proximal end” and the opposite side (end effector side) is referred to as “distal end”. In FIG. 1, for the sake of convenience of the description, an X-axis, a Y-axis and a Z-axis are shown as three axes orthogonal to each other. Also, in the description below, a direction parallel to the X-axis is referred to “X-axis direction”, a direction parallel to the Y-axis is referred to as “Y-axis direction”, and a direction parallel to the Z-axis is referred to as “Z-axis direction”. In the description below, the distal side of each arrow in the illustrations is referred to as “+ (positive)” and the proximal side is referred to as “− (negative)”. The +Y-axis direction side is referred to as “front side” and the −Y-axis direction side is referred to as “back side”. In FIG. 1, the up-down direction is referred to as “vertical direction” and the left-right direction is referred to as “horizontal direction”. In this description, the term “horizontal” includes a tilt within a range of 5 degrees or less from horizontal. Similarly, in this description, the term “vertical” includes a tilt within a range of 5 degrees or less from vertical.

A robot system 100 shown in FIG. 1 has a robot 1 and a control device 5 which controls driving of the robot 1.

### Robot

The robot 1 shown in FIG. 1 is a dual-arm robot and is used, for example, in a manufacturing process for manufacturing precision equipment or the like. Under the control of control device 5, the robot 1 can grip and carry a target object such as the precision equipment or its components.

As shown in FIG. 1, the robot 1 includes a base 210, a lift unit 240 which moves up and down in the vertical direction away from and toward the base 210, a trunk 220 connected to the base 210 via the lift unit 240, a pair of robot arms 230 (230a, 230b) connected to the left and right of the trunk 220, two force detection units 30 (30a, 30b), two end effectors 40 (40a, 40b), and a display input device 270.

As shown in FIG. 4, the robot 1 includes a plurality of drive units 131, 132 and a plurality of position sensors 135, 136 (angle sensors).

Each part forming the robot 1 will be described below.

### Base

The base 210 shown in FIG. 1 is a member supporting the trunk 220 and the robot arms 230 via the lift unit 240. The base 210 includes a basal part 2101 accommodating the control device 5, and a cylindrical column part 2102 provided on top of the basal part 2101.

The basal part 2101 is provided with a plurality of wheels (rotating members), not illustrated, a lock mechanism, not illustrated, for locking each wheel, and a handle 211 (grip part) to be gripped when moving the robot 1. Thus, the robot 1 can be moved, or fixed at a predetermined position.

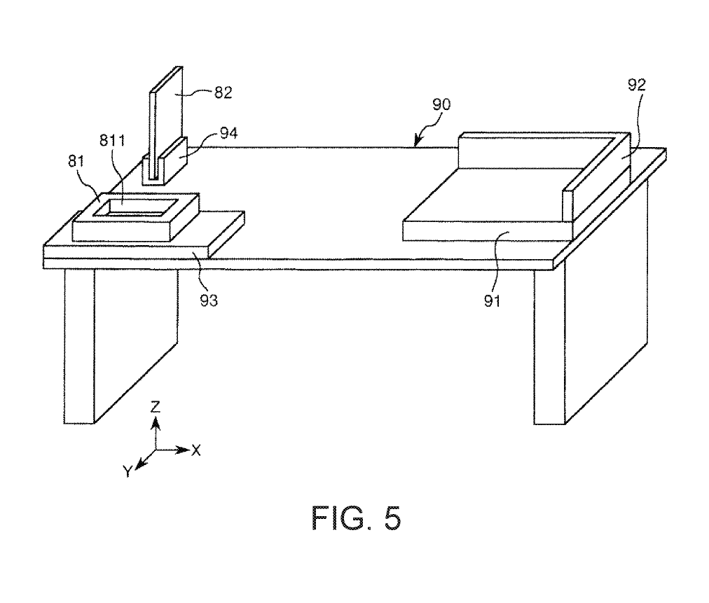

On the front side of the column part 2102, a bumper 213 is removably attached. The bumper 213 is a member used to prevent or restrain unintended contact between the robot 1 and a peripheral device (for example, a workbench 90 shown in FIG. 5, or the like) arranged around the robot 1. By bringing the bumper 213 into contact with the peripheral device, it is possible to cause the robot 1 and the peripheral device to face each other and be spaced apart from each other by a predetermined length, and therefore to prevent or restrain unintended contact between the robot 1 and the peripheral device. Also, the bumper 213 is configured in such a way as to be able to move in the vertical direction on the column part 2102 and support peripheral devices with various heights.

The column part 2102 is also provided with an emergency stop button 214. In an emergency, the emergency stop button 214 can be pressed to urgently stop the robot 1.

### Lift Unit

The lift unit 240 is connected to the column part 2102 of the base 210. The lift unit 240 includes a cylindrical casing part 2401 inserted in and thus connected to the column part 2102, and a lift mechanism (not illustrated) which is arranged in the casing part 2401 and moves the casing part 2401 up and down, for example, in the vertical direction in the column part 2102. The configuration of the lift mechanism is not particularly limited, provided that the lift mechanism can move the trunk 220 up away from and down toward the column part 2102. For example, the lift mechanism can be configured of a motor, a rack and pinion, a decelerator and the like.

### Trunk

As shown in FIG. 1, the trunk 220 is connected to the lift unit 240 or the like. Thus, the trunk 220 can move up and down in the vertical direction. Specifically, as shown in FIG. 2, the trunk 220 is connected to the lift unit 240 via a joint 310 and is rotatable about a first axis of rotation O1 along the vertical direction with respect to the lift unit 240.

The trunk 220 is also provided with a drive unit 131 including a motor (not illustrated) which generates a driving force to rotate the trunk 220 with respect to the lift unit 240 and a decelerator (not illustrated) which reduces the driving force of the motor, and a position sensor 135 (angle sensor) which detects the angle of rotation or the like of the axis of rotation of the motor provided in the drive unit 131 (see FIG. 4).

As the motor provided in the drive unit 131, for example, a servo motor such as an AC servo motor or DC servo motor can be used. As the decelerator provided in the drive unit 131, for example, a planetary gear-type decelerator, strain wave gear system or the like can be used. As the position sensor 135 (angle sensor), for example, an encoder, rotary encoder or the like can be used. Also, the drive unit 131 is controlled by the control device 5 via a motor driver (not illustrated) that is electrically connected thereto.

As shown in FIG. 1, the trunk 220 is also provided with a stereo camera 250 and a signal light 260. The stereo camera 250 is attached to the trunk 220 in such a way as to be able to pickup an image downward in the vertical direction. For example, based on data picked up by the stereo camera 250, the operator can carry out work, for example, while confirming the position of an object. Meanwhile, the signal light 260 is a device signaling the state of the robot 1 (for example, driving state, normal stop state, abnormal stop state, or the like). Thus, the operator can easily confirm the state of the robot 1.

### Robot Arm

As shown in FIG. 1, the two robot arms 230 (230a, 230b) have the same configuration. Each of the robot arms has a first arm 231 (arm, first shoulder), a second arm 232 (arm, second shoulder), a third arm 233 (arm, upper arm), a fourth arm 234 (arm, first forearm), a fifth arm 235 (arm, second forearm), a sixth arm 236 (wrist), and a seventh arm 237 (arm, connecting part). As shown in FIG. 2, each of the two robot arms 230 (230a, 230b) has seven joints 171 to 177 having a mechanism for supporting one arm rotatably with respect to the other arm (or the trunk 220).

As shown in FIG. 2, the first arm 231 is connected to the trunk 220 via the joint 171 and is rotatable about a second axis of rotation O2 orthogonal to the first axis of rotation O1 with respect to the trunk 220. The second arm 232 is connected to the first arm 231 via the joint 172 and is rotatable about a third axis of rotation O3 orthogonal to the second axis of rotation O2 with respect to the first arm 231. The third arm 233 is connected to the second arm 232 via the joint 173 and is rotatable about a fourth axis of rotation O4 orthogonal to the third axis of rotation O3 with respect to the second arm 232. The fourth arm 234 is connected to the third arm 233 via the joint 174 and is rotatable about a fifth axis of rotation O5 orthogonal to the fourth axis of rotation O4 with respect to the third arm 233. The fifth arm 235 is connected to the fourth arm 234 via the joint 175 and is rotatable about a sixth axis of rotation O6 orthogonal to the fifth axis of rotation O5 with respect to the fourth arm 234. The sixth arm 236 is connected to the fifth arm 235 via the joint 176 and is rotatable about a seventh axis of rotation O7 orthogonal to the sixth axis of rotation O6 with respect to the fifth arm 235. The seventh arm 237 is connected to the sixth arm 236 via the joint 177 and is rotatable about an eighth axis of rotation O8 orthogonal to the seventh axis of rotation O7 with respect to the sixth arm 236.

Each of the joints 171 to 177 is provided with a drive unit 132 including a motor (not illustrated) which generates a driving force to rotate each arm 231 to 237 and a decelerator (not illustrated) which reduces the driving force of the motor, and a position sensor 136 (angle sensor) which detects the angle of rotation or the like of the axis of rotation of the motor provided in the drive unit 132 (see FIG. 4). That is, the robot 1 has the drive units 132 and the position sensors 136 in the same number (in this embodiment, seven) as the seven joints 171 to 177.

As the motor provided in the drive units 132, for example, a servo motor such as an AC servo motor or DC servo motor can be used. As the decelerator provided in the drive units 132, for example, a planetary gear-type decelerator, strain wave gear system or the like can be used. As the position sensors 136 (angle sensor), for example, an encoder, rotary encoder or the like can be used. Also, each drive unit 132 is controlled by the control device 5 via a motor driver (not illustrated) that is electrically connected thereto.

In each robot arm 230 as described above, bending and extending the joints (shoulder, elbow, wrist) and twisting the upper arm and the forearm as in a human arm can be realized with a relatively simple configuration as described above.

### Force Detection Unit

As shown in FIG. 1, the force detection units 30 (30a, 30b) are removably attached to the distal end parts (bottom end parts) of the two robot arms 230.

The two force detection units 30 have the same configuration. Each force detection unit is a force detector (force sensor) which detects a force (including a moment) applied to the end effector 40. In this embodiment, as each force detection unit 30, a 6-axis force sensor capable of detecting six components, that is, translational force components Fx, Fy, Fz in the directions of three axes orthogonal to each other (x-axis, y-axis, z-axis) and rotational force components (moments) Mx, My, Mz around the three axes is used. The force detection units 30 output the result of detection (force output value) to the control device 5. Also, the force detection units 30 are not limited to the 6-axis force sensors and may be, for example, 3-axis force sensors or the like.

### End Effector

As shown in FIG. 1, the end effectors 40 (40a, 40b) are removably attached to the distal end parts (bottom end parts) of the respective force detection units 30.

The two end effectors 40 have the same configuration. Each end effector 40 is an instrument which carries out work on various objects and has the function of gripping an object. In this embodiment, as each end effector 40, a hand having a plurality of fingers 42 for gripping an object is used. Specifically, as shown in FIG. 3, the end effector 40 has an attachment part 41 as a part attached to the force detection unit 30, four fingers 42 for gripping an object, and a connecting part 43 connecting the attachment part 41 and the fingers 42. The connecting part 43 has a drive mechanism which causes the four fingers 42 to move toward and away from each other. Thus, the end effectors 40 can grip an object or release its grip.

The end effectors 40 are not limited to the illustrated configuration, provided that the end effectors 40 have the function of holding an object. For example, the end effectors 40 may be configured with a suction mechanism which attracts an object by suction. Here, the term “holding” an object includes gripping and suction or the like.

### Display Input Device

As shown in FIG. 1, the display input device 270 configured of, for example, a touch panel, is attached to the handle 211 attached to the back side of the base 210. The display input device 270 has, for example, the function as a display device configured of a liquid crystal panel which displays various screens such as operation windows, and the function as an input device configured of a touch pad or the like used by the operator to give an instruction to the control device 5. On the display input device 270, the data picked up by the stereo camera 250 is displayed. With the display input device 270 like this, the operator can confirm the state of the robot 1 and can also give an instruction to the control device 5 so that the robot 1 carries out desired work.

The robot 1 may have, for example, a display device having a liquid crystal panel or the like, and an input device such as a mouse or keyboard, instead of the display input device 270. Although the robot 1 in this embodiment is configured to have the display input device 270, the robot 1 and the display input device 270 may be separate units.

Up to this point, the configuration of the robot 1 has been briefly described. Next, the control device 5 will be described.

### Control Device

In the embodiment, the control device 5 can be configured of a personal computer (PC) or the like having a processor like a CPU (central processing unit), a ROM (read only memory), a RAM (random access memory) and the like, as built-in components. In the embodiment, the control device 5 is built in the base 210 of the robot 1, as shown in FIG. 1. However, the control device 5 may be provided outside the robot 1. Also, the control device 5 may be connected to the robot 1 via a cable and may communicate by a wired method. Alternatively, the control device 5 may communicate by a wireless method, omitting the cable.

As shown in FIG. 4, the control device 5 has a display control unit 51, an input control unit 52, a control unit 53 (robot control unit), an acquisition unit 54, and a storage unit 55.

The display control unit 51 is configured of, for example, a graphic controller and is electrically connected to the display input device 270. The display control unit 51 has the function of displaying various screens (for example, operation windows) on the display input device 270.

The input control unit 52 is configured of, for example, a touch panel controller and is electrically connected to the display input device 270. The input control unit 52 has the function of accepting an input from the display input device 270.

The control unit 53 (robot control unit) is configured of a processor or the like or can be realized by a processor executing various programs. The control unit 53 controls each part of the robot 1.

For example, the control unit 53 outputs a control signal to the drive unit 131 and thus controls the driving of the trunk 220. The control unit 53 also outputs a control signal to each drive unit 132 and thus performs coordinated control on the two robot arms 230a, 230b.

The control unit 53 also outputs a control signal to the drive unit 131 and each drive unit 132 and thus executes position control (including speed control) and force control on the robot 1.

Specifically, the control unit 53 performs position control to drive each robot arm 230 in such a way that the distal end of the end effector 40 moves along a target trajectory. More specifically, the control unit 53 controls the driving of each drive unit 131, 132 in such a way that the end effector 40 takes positions and attitudes at a plurality of target points (target positions and target attitudes) on a target trajectory. In the embodiment, the control unit 53 also performs control based on position detection information outputted from each position sensor 135, 136 (for example, the angle of rotation and angular velocity of the axis of rotation of each drive unit 131, 132). Also, in the embodiment, the control unit 53 performs, for example, CP control or PTP control as position control. The control unit 53 has the function of setting (generating) a target trajectory and setting (generating) a position and attitude of the distal end of the end effector 40 and a velocity (including an angular velocity) of the end effector 40 moving in the direction along the target trajectory.

The control unit 53 also performs force control to control the robot 1 in such a way that the end effector 40 presses (contacts) an object with a target force (desired force). Specifically, the control unit 53 controls the driving of each drive unit 131, 132 in such a way that a force (including a moment) acting on the end effector 40 becomes a target force (including a target moment). Also, the control unit 53 controls the driving of each drive unit 131, 132, based on a result of detection outputted from the force detection unit 30. In the embodiment, as the force control, the control unit 53 sets impedance (mass, coefficient of viscosity, coefficient of elasticity) corresponding to a force acting on the distal end of the end effector 40 and performs impedance control to control each drive unit 131, 132 in such a way as to realize this impedance in a simulated manner.

The control unit 53 also has the function of combining a component (amount of control) related to the position control and a component (amount of control) related to the force control, and generating and outputting a control signal to drive the robot arms 230. Therefore, the control unit 53 performs the force control, the position control, or hybrid control combining the force control and the position control, and thus causes the robot arms 230 to operate.

The control unit 53 also controls the driving of the end effectors 40, the actuation of the force detection units 30, and the actuation of the position sensors 135, 136, or the like.

The control unit 53 also has, for example, the function of carrying out various kinds of processing such as counting the number of times of work in the case of carrying out the same work a plurality of times.

The acquisition unit 54 shown in FIG. 4 acquires results of detection outputted from the force detection units 30 and the respective position sensors 135, 136.

The storage unit 55 shown in FIG. 4 has the function of storing a program and data for the control unit 53 to carry out various kinds of processing. In the storage unit 55, for example, a target trajectory and results of detection outputted from the force detection units 30 and the respective position sensors 135, 136 can be stored.

Up to this point, the configuration of the robot system 100 has been briefly described. Next, an example of work by the robot system 100 will be described and operations of the robot 1 under the control of the control device 5 will be described.

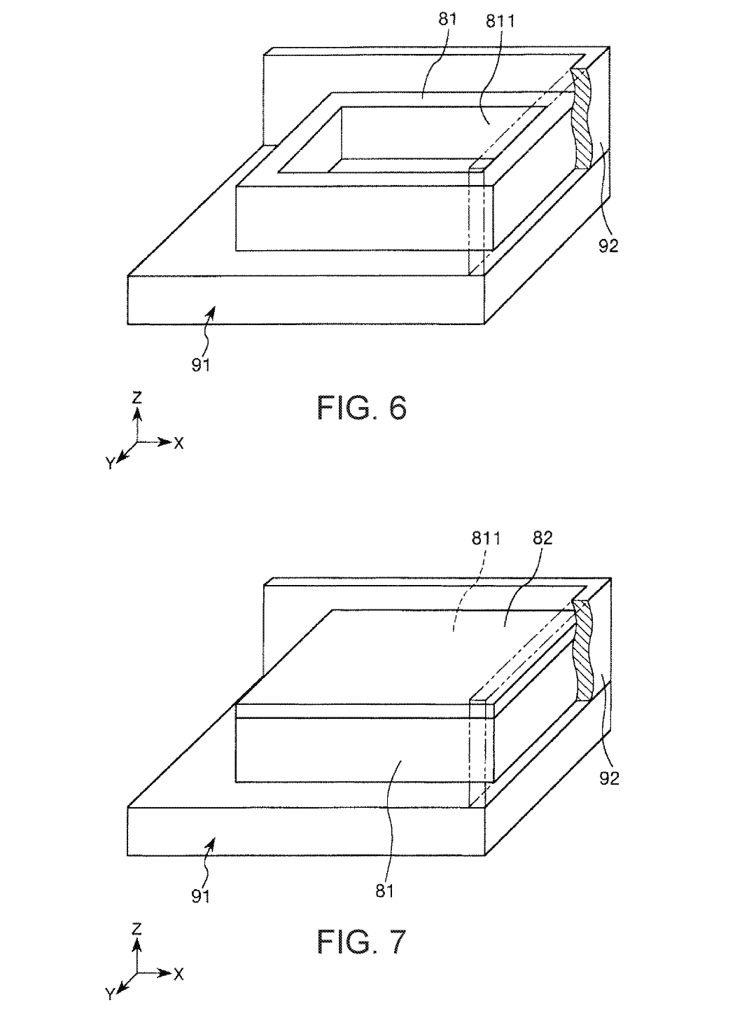

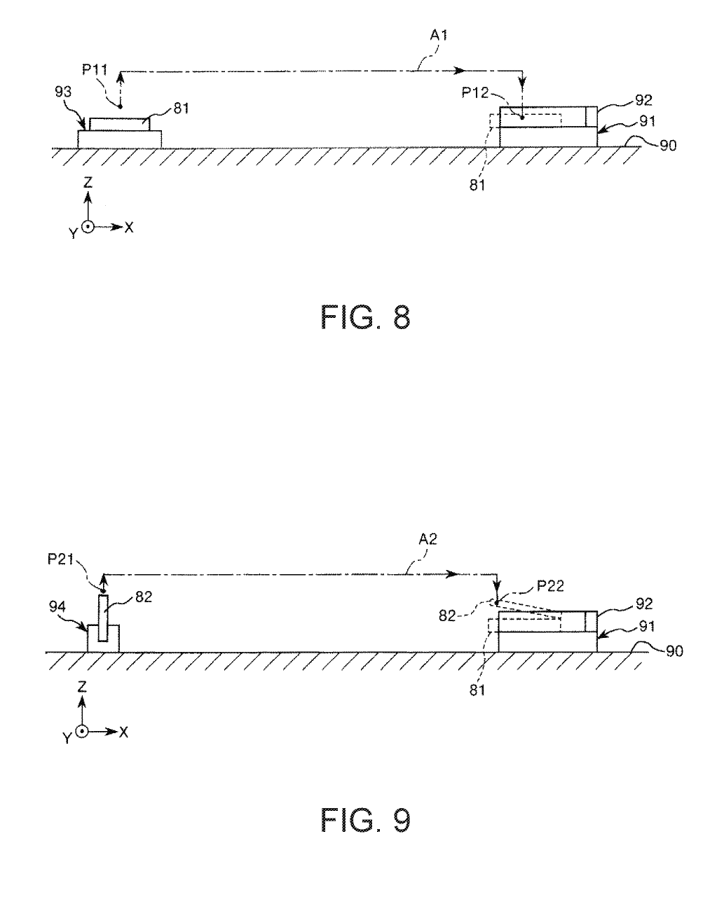

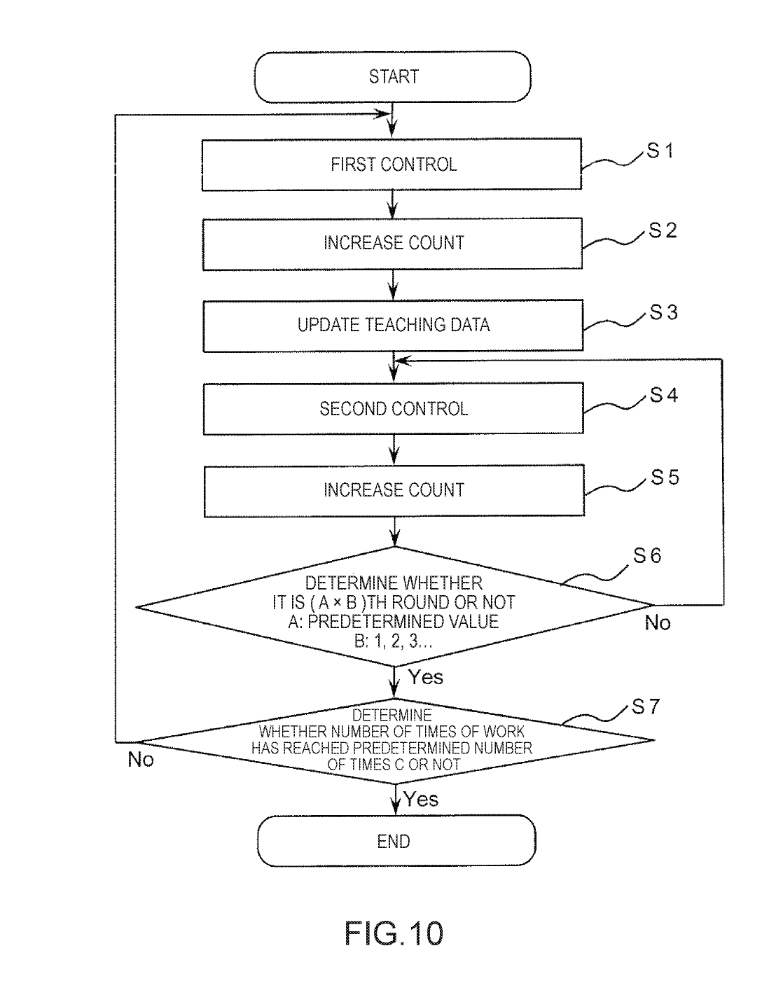

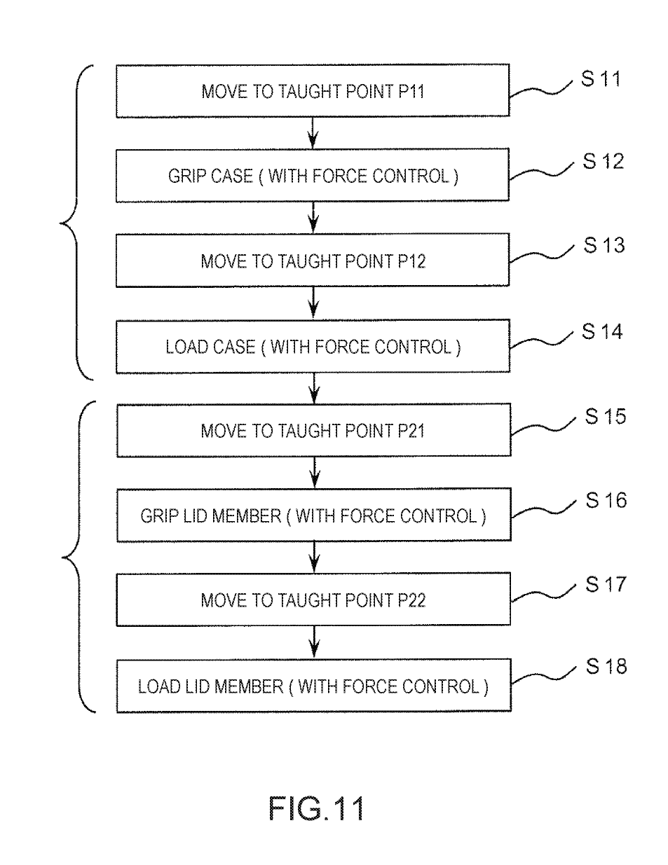

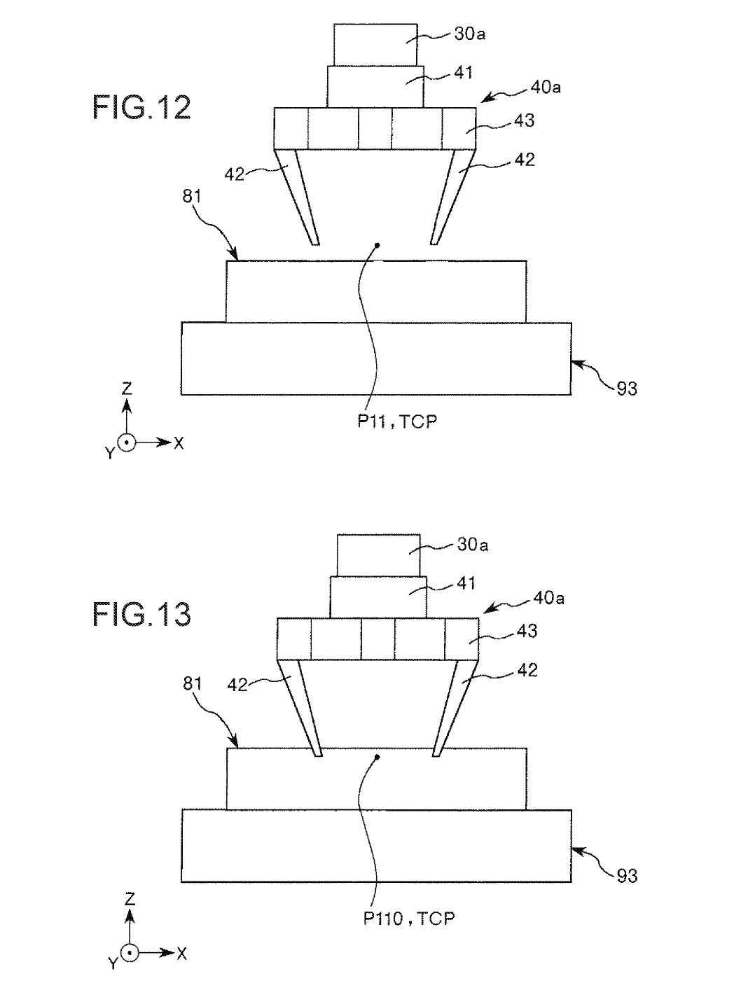

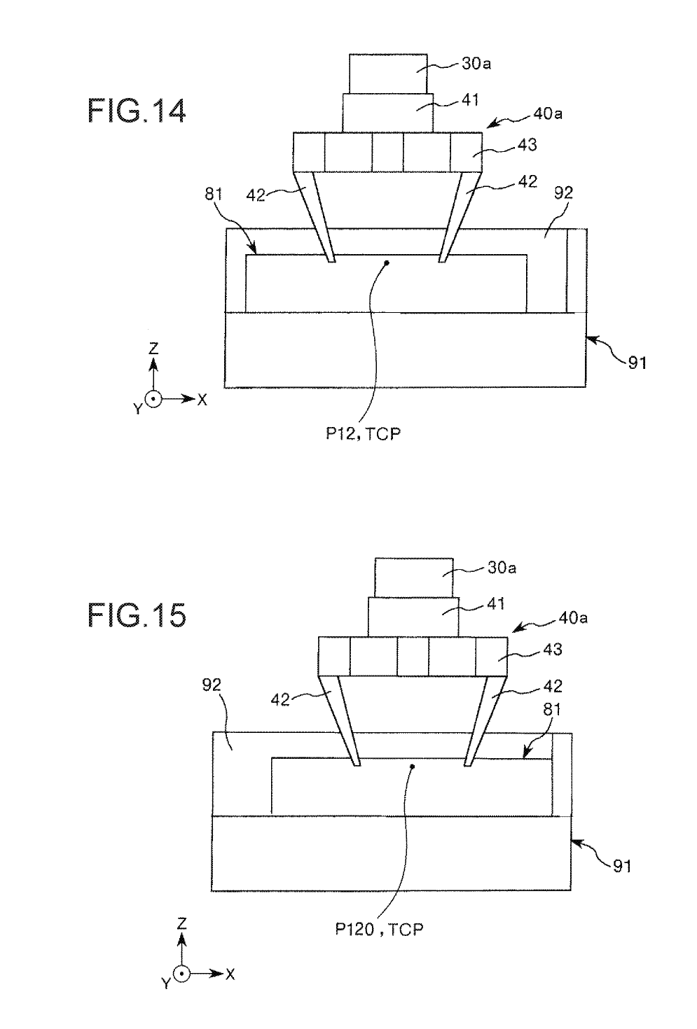

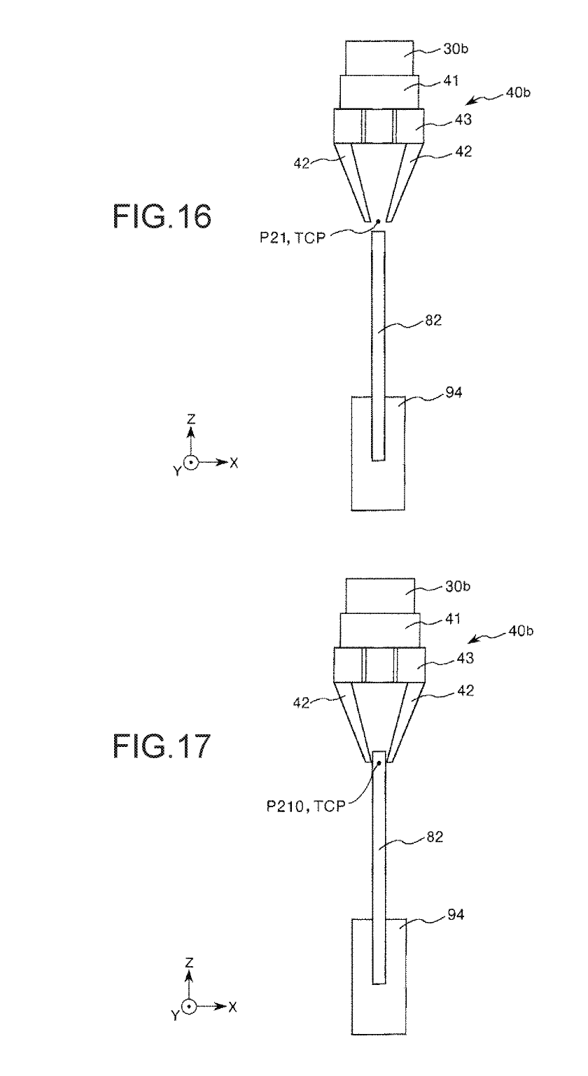

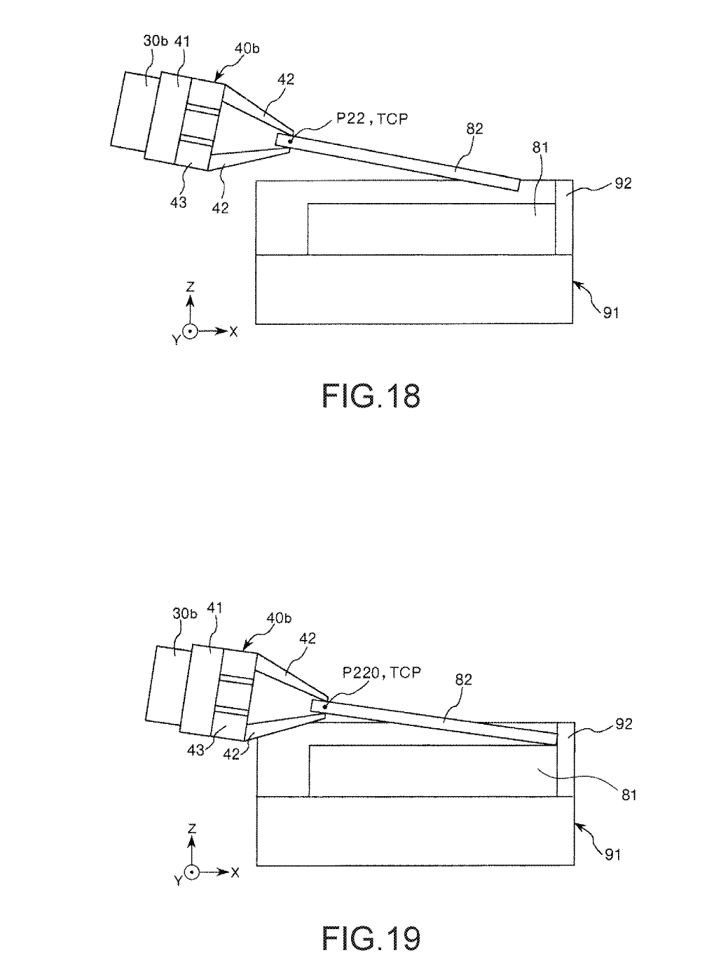

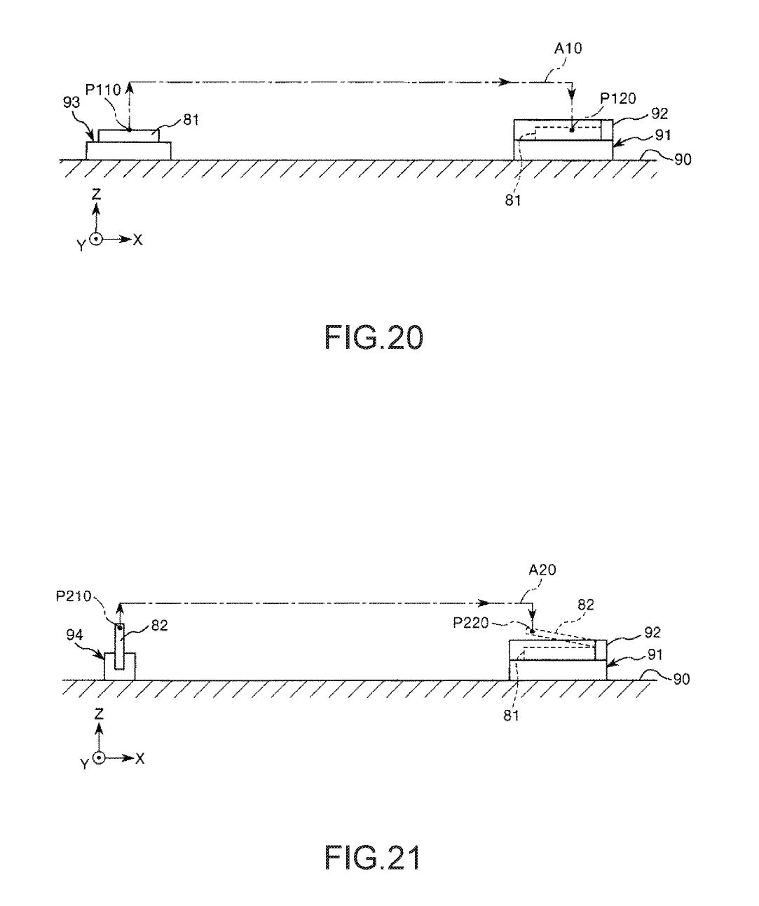

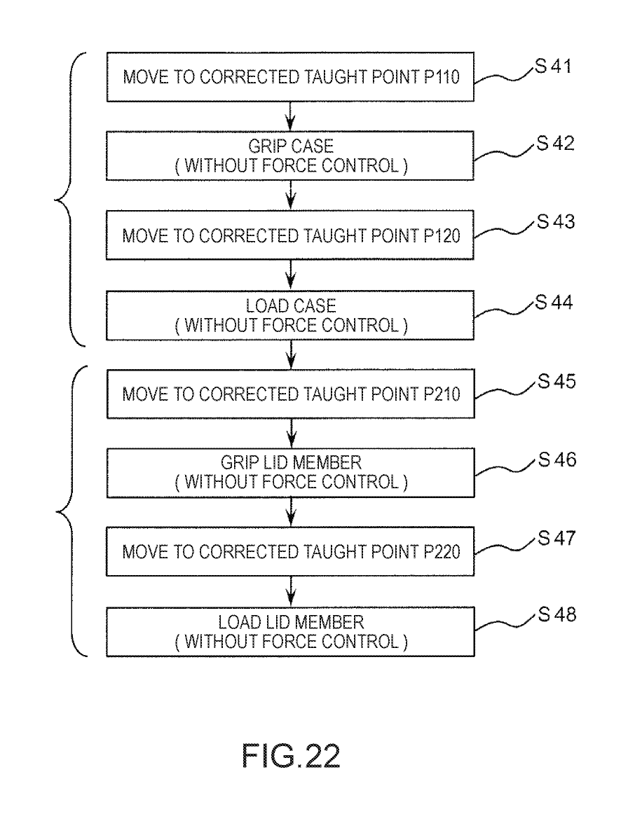

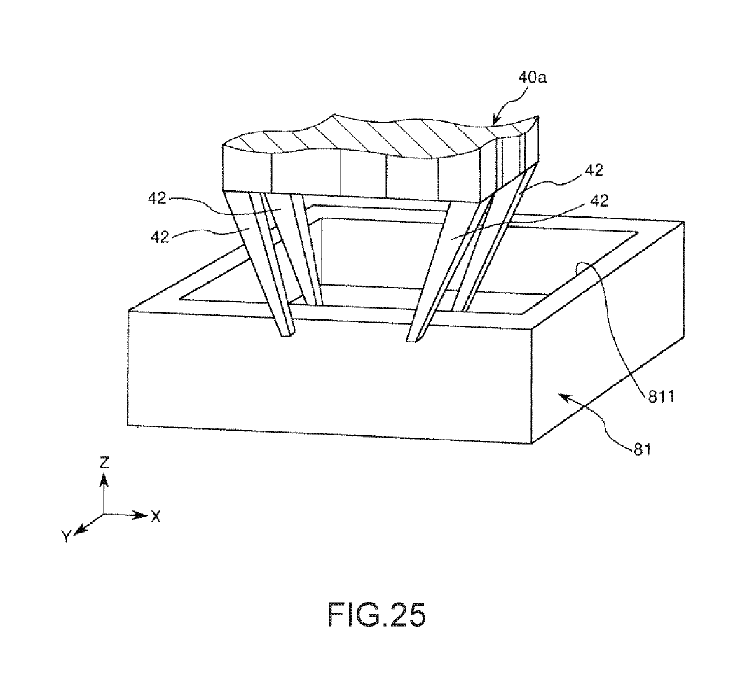

FIG. 5 shows an example of a workbench where the robot shown in FIG. 1 carries out work. FIG. 6 shows the state where a case is loaded on an assembly table shown in FIG. 5. FIG. 7 shows the state where a lid member is loaded on the case on the assembly table shown in FIG. 5. FIG. 8 shows a target trajectory A1 of the distal end of one robot arm. FIG. 9 shows a target trajectory A2 of the distal end of the other robot arm. FIG. 10 is a flowchart showing an example of work flow. FIG. 11 is a flowchart showing first control shown in FIG. 10. FIG. 12 shows the state where the distal end of one end effector is situated at a taught point P11. FIG. 13 shows the state where the distal end of the one end effector is situated at a corrected taught point P110. FIG. 14 shows the state where the distal end of the one end effector is situated at a taught point P12. FIG. 15 shows the state where the distal end of the one end effector is situated at a corrected taught point P120. FIG. 16 shows the state where the distal end of the other end effector is situated at a taught point P21. FIG. 17 shows the state where the distal end of the other end effector is situated at a corrected taught point P210. FIG. 18 shows the state where the distal end of the other end effector is situated at a taught point P22. FIG. 19 shows the state where the distal end of the other end effector is situated at a corrected taught point P220. FIG. 20 shows a target trajectory A10 obtained by correcting the target trajectory A1 shown in FIG. 8. FIG. 21 shows a target trajectory A20 obtained by correcting the target trajectory A2 shown in FIG. 9. FIG. 22 is a flowchart showing second control shown in FIG. 10. FIG. 25 is a perspective view schematically showing the state where the case is gripped by the end effector. In the respective drawings, for the sake of convenience of the description, each part is illustrated with its dimensions exaggerated according to need, and the dimension ratios between the respective parts do not necessarily coincide with their actual dimension ratios.

In the description below, assembly work of the robot 1 on a workbench 90 as shown in FIG. 5 will be described as an example. Also, in the description below, assembly work in which a plate-like lid member 82 as shown in FIG. 7 is loaded on a case 81 having a recessed part 811 as shown in FIG. 6, thus assembling the case 81 (work target object) and the lid member 82 (work target object) together, is described as an example.

On the workbench 90 shown in FIG. 5, an assembly table 91 where assembly work is carried out, a loading table 93 where the case 81 is loaded, and a loading table 94 where the lid member 82 is loaded are provided. With the one end effector 40a, the robot 1 grips the case 81 on the loading table 93 and carries and loads the case 81 onto the assembly table 91 (see FIGS. 5 and 6). With the other end effector 40b, the robot 1 grips the lid member 82 on the loading table 94 and carries and loads the lid member 82 onto the case 81 (see FIGS. 5 and 7). In this way, the robot 1 carries out assembly work. On the assembly table 91, an abutting plate 92 serving to position the case 81 and the lid member 82 on the assembly table 91 is provided. The case 81 and the lid member 82 are abutted against the abutting plate 92 and thereby positioned on the assembly table 91.

The driving of the robot in the assembly work is taught, for example, by direct teaching. Based on teaching data obtained by this teaching, the control device 5 drives the robot 1. The teaching data includes the target trajectory A1 of the distal end of the end effector 40a (see FIG. 8), the target trajectory A2 of the distal end of the end effector 40b (see FIG. 9), and an operation command or the like related to the driving of each part of the robot arms 230a, 230b.

The target trajectory A1 shown in FIG. 8 is a path on which the distal end (tool center point TCP) of the end effector 40a moves. The target trajectory A2 shown in FIG. 9 is a path on which the distal end (tool center point TCP) of the end effector 40b moves. In the embodiment, the tool center point TCP is the part between the respective distal ends of the four fingers 42. (see FIG. 3).

The taught point P11 on the target trajectory A1 shown in FIG. 8 is a point near (directly above) the case 81 on the loading table 93. The taught point P12 on the target trajectory A1 is a point near (directly above) the case 81 on the assembly table 91. The taught point P21 on the target trajectory A2 shown in FIG. 9 is a point near (directly above) the lid member 82 on the loading table 94. The taught point P22 on the target trajectory A2 is a point near (directly above) the lid member 82 on the case 81 loaded on the assembly table 91.

Each of the target trajectories A1, A2 is not limited to the path generated based on the teaching by directly teaching and may be, for example, a path generated based on CAD data or the like.

Hereinafter, the assembly work will be described in detail, referring to the work flow shown in FIG. 10. In the embodiment, the assembly work is carried out a plurality of times. That is, the same assembly work is carried out a plurality of times on the same work target objects (case 81 and lid member 82).

### First Control (Step S1)

When an instruction to start work is given by the operator, the control device 5 first starts first control (Step S1), as shown in FIG. 10, and carries out the first round of assembly work. This first control (Step S1) will be described, referring to the flowchart shown in FIG. 11, and the illustrations shown in FIGS. 8, 9, 12 to 21.

First, the control unit 53 drives the robot arm 230a by position control and thus causes the distal end (tool center point TCP) of the end effector 40a to be positioned at the taught point P11 as shown in FIG. 12 (Step S11 in FIG. 11).

Next, the control unit 53 starts force control and drives the robot arm 230a, based on the result of detection by the force detection unit 30a. When contact between the case 81 and the end effector 40a is detected, the control unit 53 causes the end effector 40a to grip the case 81 as shown in FIG. 13 (Step S12 in FIG. 11). More specifically, as shown in FIG. 25, one side of an edge part (lateral part) of the case 81 is gripped with the four fingers 42 of the end effector 40a. The position of the distal end of the end effector 40a at this time is stored as the corrected taught point P110 obtained by correcting the taught point P11.

Next, the control unit 53 drives the robot arm 230a by position control and thus causes the distal end of the end effector 40a to move along the target trajectory A1 (see FIG. 8). Then, the control unit 53 causes the distal end of the end effector 40a to be situated at the taught point P12 as shown in FIG. 14 (Step S13 in FIG. 11).

Next, the control unit 53 starts force control and drives the robot arm 230a, based on the result of detection by the force detection unit 30a. The control unit 53 detects contact between the case 81, and the top surface of the assembly table 91 and the abutting plate 92, and completes the loading of the case 81 as shown in FIG. 15 (Step S14 in FIG. 11). When the loading of the case 81 is completed, the end effector 40a is released from the case 81. In Step S14, the position of the distal end of the end effector 40a when the loading of the case 81 is completed is stored as the corrected taught point P120 obtained by correcting the taught point P12.

Next, the control unit 53 drives the robot arm 230b by position control and thus causes the distal end (tool center point TCP) of the end effector 40b to be situated at the taught point P21 as shown in FIG. 16 (Step S15 in FIG. 11).

Next, the control unit 53 starts force control and drives the robot arm 230b, based on the result of detection by the force detection unit 30b. The control unit 53 detects contact between the lid member 82 and the end effector 40b and causes the end effector 40b to grip the lid member 82 as shown in FIG. 17 (Step S16 in FIG. 11). The position of the distal end of the end effector 40b at this time is stored as the corrected taught point P210 obtained by correcting the taught point P21.

Next, the control unit 53 drives the robot arm 230b by position control and thus causes the distal end of the end effector 40b to move along the target trajectory A2 (see FIG. 9). Then, the control unit 53 causes the distal end of the end effector 40b to be situated at the taught point P22 as shown in FIG. 18 (Step S17 in FIG. 11).

Next, the control unit 53 starts force control and drives the robot arm 230b, based on the result of detection by the force detection unit 30b. When contact between the lid member 82, and the top surface of the case 81 and the abutting plate 92, is detected, the control unit 53 completes the loading of the lid member 82 onto the case 81 as shown in FIG. 19 (Step S18 in FIG. 11). In Step S18, the position of the distal end of the end effector 40b when the loading of the lid member 82 is completed is stored as the corrected taught point P220 obtained by correcting the taught point P22.

Thus, the first control (Step S1) shown in FIG. 10 ends and the first round of assembly work by the robot 1 ends. As described above, in the first control (Step S1), force control (particularly impedance control) is carried out so as to carry out the gripping of the case 81 and the lid member 82 and the loading of the case 81 and the lid member 82. Therefore, the application of an unwanted force to each of the case 81 and the lid member 82 can be restrained or prevented and positioning accuracy can be increased as well. In this embodiment of the invention, the order in which Steps S11 to S14 and Steps S15 to S18 are executed is not limited to this example. Steps S11 to S14 and Steps S15 to S18 may be carried out simultaneously or may partly overlap each other in terms of time.

### Increase in Count (Step S2)

Next, as shown in FIG. 10, the control unit 53 increases the count of the number of times of the assembly work by the robot 1 (Step S2). Starting with an initial value of “0 (zero)”, the control unit 53 increases the count of the number of times of the assembly work to, for example, “1” in Step S2.

### Update of Data (Step S3)

Next, as shown in FIG. 10, the control unit 53 updates (corrects) the taught points P11, P12, P21, P22 to the corrected taught points P110, P120, P210, P220 recorded in the first control (Step S1), and updates (corrects) preset teaching data (Step S3). Thus, new teaching data generated based on the first round of work can be obtained. This new teaching data includes the target trajectory A10 (corrected target trajectory) as shown in FIG. 20 obtained by correcting the target trajectory A1 shown in FIG. 8, the target trajectory A20 (corrected target trajectory) as shown in FIG. 21 obtained by correcting the target trajectory A2 shown in FIG. 9, and an operation command or the like related to the driving of each part of the robot arms 230a, 230b for the distal ends of the end effectors 40a, 40b to move along the target trajectories A10, A20.

### Second Control (Step S4)

Next, as shown in FIG. 10, the control unit 53 starts second control (Step S4) and carries out the second round of assembly work. This second control (Step S4) will be described, referring to the flowchart shown in FIG. 22.

First, the control unit 53 drives the robot arm 230a by position control, and thus causes the distal end of the end effector 40a to be positioned at the corrected taught point P110 (Step S41 in FIG. 22) and causes the end effector 40a to grip the case 81 (Step S42 in FIG. 22). This case 81 has the same shape and the same weight as the case 81 in the first round of assembly work.

Next, the control unit 53 drives the robot arm 230a by position control and thus causes the distal end of the end effector 40a to move along the target trajectory A10 (see FIG. 20). Then, the control unit 53 causes the distal end of the end effector 40a to be situated at the corrected taught point P120 (Step S43 in FIG. 22) and completes the loading of the case 81 (Step S44 in FIG. 22). When the loading of the case 81 is completed, the end effector 40a is released from the case 81.

Next, the control unit 53 drives the robot arm 230b by position control, and thus causes the distal end of the end effector 40b to be situated at the corrected taught point P210 (Step S45 in FIG. 22) and causes the end effector 40b to grip the lid member 82 (Step S46 in FIG. 22). This lid member 82 has the same shape and the same weight as the lid member 82 in the first round of assembly work.

Next, the control unit 53 drives the robot arm 230b by position control and thus causes the distal end of the end effector 40b to move along the target trajectory A20 (see FIG. 21). Then, the control unit 53 causes the distal end of the end effector 40b to be situated at the corrected taught point P220 (Step S47 in FIG. 22) and completes the loading of the lid member 82 onto the case 81 (Step S48 in FIG. 22).

In this embodiment of the invention, the order in which Steps S41 to S44 and Steps S45 to S48 are executed is not limited to this example. Steps S41 to S44 and Steps S45 to S48 may be carried out simultaneously or may partly overlap each other in terms of time.

Thus, the second control (Step S4) shown in FIG. 10 ends and the second round of assembly work by the robot 1 ends. In the second round of work, position control is carried out based on the teaching data newly obtained in the first round of work, as described above. Therefore, even without force control, the distal ends of the end effectors 40 can be properly situated at the corrected taught points P110, P120, P210, P220. Also, when the robot arms 230 are driven by force control, the operating speeds of the robot arms 230 tend to slow down due to insufficient responsiveness or control cycle of the force detection units 30. However, in the second round of work, since force control can be omitted as in this embodiment, the operating speeds of the robot arms 230 can be made faster than in the first round of work.

Moreover, in the embodiment, the control unit 53 is to detect an abnormality of the robot 1 based on outputs from the force detection units 30 while performing position control in the second control. Although not shown in the work flow shown in FIG. 10, if an abnormality is detected, the control unit 53 performs control, for example, so as to stop the driving of the robot 1 or to redo the first round of work according to need. Thus, assembly work can be carried out more stably. The term “abnormality” refers to, for example, the case where the result of detection (output value) from the force detection units 30 exceeds a predetermined value that is set arbitrarily. Specifically, for example, an abnormality in work may be the case where the end effectors 40 are excessively pressing the case 81 or the lid member 82, or the like. For example, the position control is to situate the distal end of the end effector 40, for example, at a target point in the real space. Therefore, there are cases where the lid member 82 is pressed excessively against the case 81 due to a dimensional error or the like in the case 81 and the lid member 82 used. Therefore, by detecting outputs from the force detection units 30 in the position control, it is possible to avoid the application of an unwanted force to the case 81 or the lid member 82 without carrying out force control.

### Increase in Count (Step S5)

Next, as shown in FIG. 10, the control unit 53 increases the count of the number of times of the assembly work by the robot 1 (Step S5). The control unit 53 increases the count of the number of times of the assembly work to, for example, “2” in Step S5.

### Determination on Whether it is (A×B)Th Round or not (Step S6)

Next, as shown in FIG. 10, the control unit 53 determines whether the number of times of assembly work is a multiple of a predetermined value A that is set arbitrarily by the operator, or not (Step S6). That is, the control unit 53 determines whether the number of times of assembly work is a multiplied value (A×B) of the predetermined value A and an integer B (1, 2, 3 . . . ) or not. For example, if the predetermined value A is “10”, the control unit 53 determines whether the multiplied value is one of “10, 20, 30 . . . ” or not. If the number of times of assembly work is not the multiplied value (A×B), that is, if it is not the (A×B)th round (No in Step S6), the second control (Step S4) and the increase in count (Step S5) are repeated until it is the (A×B)th round. Therefore, in other rounds of work except the (A×B)th round (for example, 10, 20, 30 . . . ), force control is omitted and assembly work is carried out by position control. Thus, the operating speeds of the robot arms 230 can be made faster and therefore the cycle time in a plurality of rounds of assembly work can be reduced.

### Determination on Whether the Number of Times of Work has Reached a Predetermined Number of Times C or not (Step S7)

Next, as shown in FIG. 10, if the number of times of work is A×B (Yes in Step S6), the control unit 53 determines whether the number of times of work has reached a predetermined number of times C that is set arbitrarily by the operator, or not, that is, whether the number of times of work has reached a number of times scheduled to finish the work or not (Step S7). For example, if the predetermined number of times C (number of times scheduled to finish the work) is “30” and the predetermined number of times C of “30” is not achieved (No in Step S7), the control unit 53 returns to the first control (Step S1). Therefore, until the predetermined number of times C is achieved, force control based on the result of detection by the force detection units 30 is carried out every (A×B)th round. Therefore, every (A×B)th round, it is possible to confirm whether precise positioning is successfully realized or not, and to correct the corrected taught points P110, P120, P210, P220 again and generate new teaching data again. Thus, even if work is repeated a plurality of times, work with particularly high positioning accuracy can be realized.

Meanwhile, if the predetermined number of times C of “30” is achieved (Yes in Step S7), the assembly work ends.

In this way, a plurality of rounds of assembly work ends.

As described above, the control device 5 as an example of the control device according to the invention controls the driving of the robot 1 having the force detection units 30 (30a, 30b). The control device 5 has the control unit 53. The control unit 53, when causing the robot 1 to carry out work a plurality of times, performs force control on the robot 1 based on an output (result of detection) from the force detection units 30 and teaches the corrected taught points P110, P120, P210, P220 as the “first position”, in the first round of work. In the second round of work, the control unit 53 performs position control on the robot 1 based on the data (first position data) related to the corrected taught points P110, P120, P210, P220 obtained in the first round of work, and causes the distal ends of the end effectors 40 (40a, 40b) as the “predetermined site” of the robot 1 to move to the corrected taught points P110, P120, P210, P220. With the control device 5 like this, since force control is carried out in the first round of work, precise positioning can be realized, and in the second round of work, position control can be carried out based on new teaching data including first position data obtained in the first round of work. Therefore, in the second round of work, precise positioning can be realized even if force control is omitted, and the operating speeds of the robot arms 230 (movement speed of the distal ends of the end effectors 40) can be made faster than in the first round of work, due to the omission of force control. Thus, for example, a high-quality product (product obtained by assembling the case 81 and the lid member 82 together) can be produced stably in a large number and therefore productivity of this product can be increased.

In this embodiment, each of the corrected taught points P110, P120, P210, P220 is regarded as the “first position” and it is assumed that a plurality of first positions exists. However, it is also possible to regard only one arbitrary corrected taught point of the corrected taught points P110, P120, P210, P220, as the “first position”. That is, the “first position” may be a taught point obtained by performing force control (or a corrected taught point obtained by correcting a taught point as in the embodiment), and the taught point may be in a plural number or may be just one. Also, while the distal ends of the end effectors 40 are defined as the “predetermined sites” in the embodiment, the “predetermined site” may be any arbitrary site of the robot 1 and is not limited to the distal ends of the end effectors 40. For example, the “predetermined site” may be the distal end of the seventh arm 237, or the like.

The first position data is obtained by performing force control in the first round of work and thus correcting data about the taught points P11, P12, P21, P22 as the “first taught points” set in advance. Here, while the first position data may be data about the taught point (first position) obtained by performing force control, as described above, it is preferable that the first position data is data (corrected taught points P110, P120, P210, P220) obtained by correcting the data about the taught points P11, P12, P21, P22 set in advance, as in the embodiment. Thus, first position data about a more appropriate position in work and new teaching data including the first position data can be obtained.

As described above, in the second and subsequent rounds of work (in the embodiment, for example, the second to ninth rounds of work), the control unit 53 performs position control on the robot 1 based on the first position data, and thus causes the distal ends of the end effectors 40 as the “predetermined sites” of the robot 1 to move to the corrected taught points P110, P120, P210, P220 as the “first positions”. Thus, not only in the second round of work but also in the subsequent rounds of work, the operating speeds of the robot arms 230 can be made faster by omitting force control. Therefore, the cycle time can be reduced in a plurality of rounds of work and thus productivity can be increased further.

The term “second and subsequent rounds of work” is not limited to the entirety of the second and subsequent rounds of work and includes an arbitrary number of rounds from the second round of work, such as the second to ninth rounds of work as in the embodiment.

Moreover, as described above, in the (A×B)th round (for example, 10, 20, 30 . . . ) of work as the “predetermined round” prescribed in the appended claims, the control unit 53 performs force control on the robot 1 based on outputs from the force detection units 30 and thus causes the end effectors 40 as the “predetermined sites” to move to the corrected taught points P110, P120, P210, P220 as the “first positions”. In this way, in the (A×B)th round other than the first round, force control is performed so as to cause the end effectors 40 to move to the corrected taught points P110, P120, P210, P220. That is, work involving force control based on the result of detection by the force detection units 30 is carried out every (A×B)th round. Thus, disadvantages (for example, increase in time and effort taken) of performing force control in all rounds can be eliminated and it is possible to confirm whether precise positioning is successfully realized or not and to correct the first position data about the corrected taught points P110, P120, P210, P220, every (A×B)th round. Therefore, even if work is repeated a plurality of times, it is possible to realize work with particularly high position accuracy and to keep producing high-quality products stably.

In the embodiment, the case where the “predetermined round” prescribed in the appended claims is regarded as the (A×B)th round (for example, 10, 20, 30 . . . ) is described as an example. However, the “predetermined round” refers to an arbitrary number of times and is not limited to the (A×B)th round (for example, 10, 20, 30 . . . ).

In the embodiment, the “first round” prescribed in the appended claims is the first round as described above. Since precise positioning is thus realized by force control in the first round of work, which is the beginning of a plurality of rounds of work, it is possible to cause the robot to carry out the second and subsequent rounds of work properly and a relatively high speed.

The case where the “first round” and the “second round” prescribed in the appended claims are regarded as the first round and the second round in the embodiment is described as an example. However, the “first round” and the “second round” prescribed in the appended claims are not limited to this example. For example, the “first round” and the “second round” prescribed in the appended claims may be regarded as the second round and the third round in the embodiment. In that case, work involving force control may be carried out in the second round of work, and work without force control may be carried out in the third round of work. In the first round of work, work involving force control may be carried out, as in the second round of work. That is, after the two rounds (first round and second round) of work involving force control, the third round of work without force control may be carried out. Thus, since the third round of work can be carried out based on new teaching data obtained from the two rounds of work involving force control, the positioning accuracy in the third round of work can be improved further.

As described above, the control unit 53 detects an abnormality of the robot 1 based on outputs from the force detection units 30, while performing position control. Particularly, it is preferable that the control unit 53 detects an abnormality of the robot 1 when the case 81 gripped by the end effector 40 is in contact with the assembly table 91 and when the lid member 82 gripped by the end effector 40 is in contact with the case 81. That is, it is preferable that the control unit 53 detects an abnormality of the robot 1 based on outputs from the force detection units 30 when the end effectors 40 or the case 81 and the lid member 82 gripped (held) by the end effectors 40 are in contact with peripheral members (for example, the assembly table 91 or the like). Thus, when an abnormality is detected, the control unit 53 can perform control, for example, in such a way as to stop driving the robot 1 or to redo the first round of work. Therefore, it is possible to avoid the application of an unwanted force to the case 81 or the lid member 82 in position control without performing force control, and to stably produce a high-quality product in a large number.

The robot 1 as an example of the robot according to the invention has the force detection units 30, carries out work a plurality of times, and is controlled by the control device 5, as described above. With this robot 1, under the control of the control device 5, the cycle time in the work can be reduced while precise positioning is realized. Thus, productivity can be increased further.

Moreover, in the embodiment, the robot 1 has a plurality of (in the embodiment, two) robot arms 230, and the force detection unit 30 is provided on all of the plurality of robot arms 230. Thus, the driving of each of the plurality of robot arms 230 can be controlled with high accuracy. Also, generally, in the robot 1 having the plurality of robot arms 230, the arm width is configured to be relatively narrow in consideration of the arrangement or the like of the robot arms 230 with respect to each other. Therefore, precise positioning tends to be difficult due to insufficient rigidity of the robot arms 230. However, the control device 5 according to the embodiment enables an increase in positioning accuracy even with the robot 1 as described above, and thus enables an increase in productivity.

In the embodiment, the case where the force detection unit 30 is provided on all of the plurality of robot arms 230 is described as an example. However, the force detection units 30 may be omitted, depending on the content or the like of the work by the robot 1. Therefore, it suffices that the force detection unit 30 is provided on at least one of the plurality of robot arms 230.

In the foregoing description, in the second and subsequent rounds of work, force control is omitted from the entire processing (Steps S41 to S48). However, both of force control and position control may be carried out in arbitrary part of the processing. For example, in Steps S43 and S44 described above, it is possible to move to the corrected taught point P120 by position control and to load the case 81 onto the assembly table 91 by force control. That is, for example, in the second round of work, the control unit 53 may execute position control without force control with respect to the corrected taught points P110, P210, P220 (first positions) and may execute force control and position control with respect to the corrected taught point P120 (second position).

Therefore, for example, in one type of work (for example, the above assembly work), the control unit 53 can separately teach the corrected taught points P110, P210, P220 (first positions) and the corrected taught point P120 (second position) that is different from these. In the first round of work, the control unit 53 performs force control on the robot 1 based on an output from the force detection unit 30, thus teaches the corrected taught points P110, P210, P220, and also teaches the corrected taught point P120. In the second round of work, the control unit 53 performs position control with respect to the corrected taught points P110, P210, P220 and drives the robot 1, based on first position data about the corrected taught points P110, P210, P220 obtained in the first round of work, and thus causes the distal end of the end effector 40 as the “predetermined site” to be situated at the corrected taught points P110, P210, P220. In the second round of work, the control unit 53 performs position control to control the robot 1 based on second position data about the corrected taught point P120 obtained in the first round of work and force control to control the robot 1 based on an output from the force detection unit 30 so as to drive the robot 1, and thus causes the distal end of the end effector 40 as the “predetermined site” to be situated at the corrected taught point P120. As described above, in the second round of work, processing to perform force control is carried out along with position control, for example, in the processing related to loading the case 81 onto the assembly table 91 (Steps S43, S44). The loading of the case 81 onto the assembly table 91 can greatly influence the position accuracy of the subsequent processing of loading the lid member 82 onto the case 81. Therefore, by performing position control and force control in such processing, it is possible to accurately carry out the assembly of the case 81 and the lid member 82 in the second round of work. Thus, by using the processing in which only position control based on the first position data is carried out (for example, steps excluding Steps S43, S44) and the processing in which both of position control and force control based on the second position data are carried out (for example, Steps S43, S44), depending on the content of processing or the like in the second round of work, it is possible to cause the robot 1 to carry out the assembly work more accurately and quickly.

Carrying out both of position control and force control depending on the content of processing or the like in the second round of work is particularly effective, for example, in fitting work as described below.

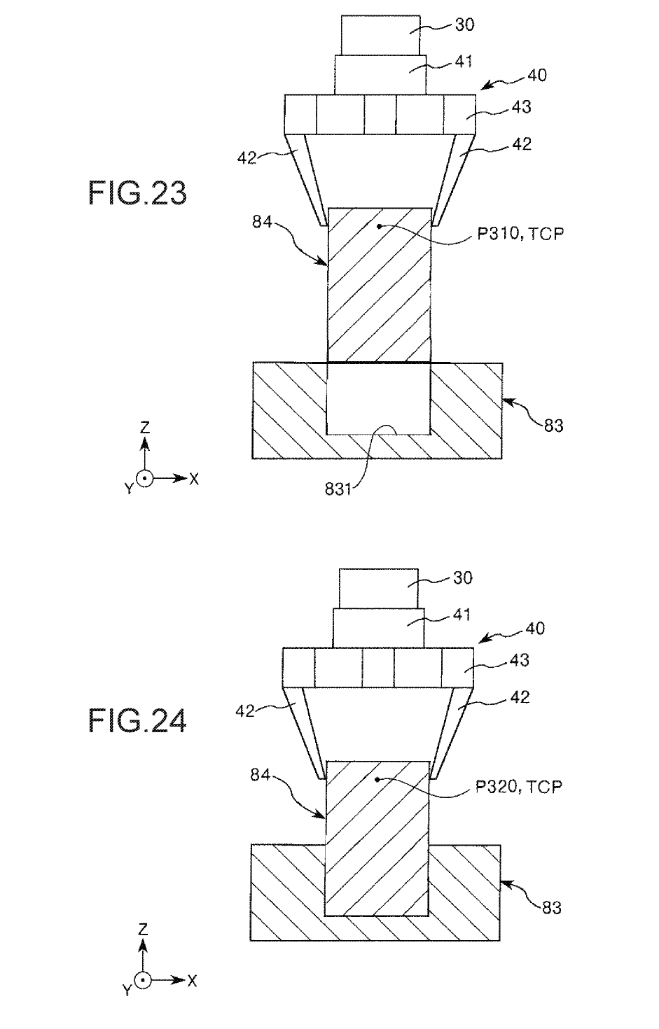

FIG. 23 shows the state where the distal end of the end effector is situated at a corrected taught point P310. FIG. 24 shows the state where the distal end of the end effector is situated at a corrected taught point P320.

As shown in FIGS. 23 and 24, fitting work in which a cubic fitting member 84 is fitted into a fitting target member 83 having a recessed part 831 corresponding to the outer shape of the fitting member 84 will be described as an example.

For example, as shown in FIG. 23, the corrected taught point P310 of the distal end of the end effector 40 before the fitting member 84 is inserted into the recessed part 831 is defined as the “first position”. Meanwhile, as shown in FIG. 24, the corrected taught point P320 of the distal end of the end effector 40 when the fitting member 84 is inserted in the recessed part 831 and comes in contact with the bottom surface of the recessed part 831, that is, immediately before the fitting member 84 comes in contact with the bottom surface of the recessed part 831, is defined as the “second position”. Then, for example, in the second round of work, position control is performed until before the fitting member 84 is inserted in the recessed part 831 and reaches the bottom surface of the recessed part 831, that is, until immediately before the fitting member 84 comes in contact with the bottom surface of the recessed part 831. When the fitting member 84 is in contact with the bottom surface of the recessed part 831, force control is performed. More specifically, position control and force control are performed immediately before the fitting member 84 comes in contact with the bottom surface of the recessed part 831, and force control is performed after the fitting member 84 comes in contact with the bottom surface of the recessed part 831.

That is, in one type of work (for example, the foregoing fitting work), the control unit 53 can teach the corrected taught point P310 (first position) and the corrected taught point P320 (second position) that is different from the corrected taught point P310. In the first round of work, the control unit 53 performs force control on the robot 1 based on an output from the force detection unit 30, and teaches the corrected taught point P310 and also teaches the corrected taught point P320. In the second round of work, the control unit 53 performs position control with respect to the corrected taught point P310 so as to drive the robot 1, based on the first position data about the corrected taught point P310 obtained in the first round of work, and thus causes the distal end of the end effector 40 as the “predetermined site” to be situated at the corrected taught point P310. In the second round of work, the control unit 53 performs position control to control the robot 1 based on the second position data about the corrected taught point P320 obtained in the first round of work and force control to control the robot 1 based on an output from the force detection unit 30 so as to drive the robot 1, and thus causes the distal end of the end effector 40 as the “predetermined site” to be situated at the corrected taught point P320. Particularly, in this embodiment, only force control is performed after position data based on the first position data is performed and position control and force control based on the second position data are performed.

Thus, in the second round of work, the fitting work can be carried out quickly, and near the end of the fitting, whether the fitting work is properly carried out or not can be confirmed based on an output from the force detection unit 30. By thus using the processing of performing position control based on the first position data and the processing of performing both of position control and force control based on the second position data in the second round (and subsequent rounds) of work, it is possible to cause the robot 1 to carry out the fitting work more accurately and quickly.

The robot system 100 as an example of the robot system according to the invention as described above includes the control device 5, and the robot 1 controlled by the control device 5 and having the force detection unit 30. With the robot system 100 like this, under the control of the control device 5, precise positioning can be realized in the work by the robot 1 and the cycle time in the work by the robot 1 can be reduced. Therefore, the productivity of the product can be increased.

The control device, the robot and the robot system according to the embodiment have been described, based on the illustrated embodiments. However, the invention is not limited to this. The configuration of each part can be replaced with an arbitrary configuration having the same functions. Also, another arbitrary component may be added to the invention. The respective embodiments may be combined where appropriate.

The number of axes of rotations of the robot arm is not particularly limited and may be arbitrary. Also, the number of robot arms is not particularly limited and may be one, or three or more. Moreover, the robot may be a so-called horizontal multi-joint robot.

In the embodiments described above, an example in which the force detection unit is provided at the distal end part of the robot arm is described. However, the site where the force detection unit is installed may be any site, provided that the force detection unit can detect a force or moment applied to an arbitrary site of the robot. For example, the force detection unit may be provided at the proximal end part of the sixth arm (between the fifth arm and the sixth arm).

The entire disclosure of Japanese Patent Application Nos. 2016-205739, filed Oct. 20, 2016 and 2017-148235, filed Jul. 31, 2017 are expressly incorporated by reference herein.

What is claimed is:

1. A control device for controlling driving of a robot having a force detection unit, the control device comprising:
a processor that is configured to perform force control on the robot based on an output from the force detection unit and teach the robot a first position in a first round of the work when causing the robot to carry out work a plurality of times, and the processor is configured to perform position control on the robot based on first position data about the first position acquired in the first round of the work and causes a predetermined site of the robot to move to the first position in a second round of the work.

2. The control device according to claim 1, wherein the processor is configured to perform position control on the robot based on the first position data and causes the predetermined site of the robot to move to the first position in the second and subsequent rounds of the work.

3. The control device according to claim 1, wherein the processor is configured to perform force control on the robot based on an output from the force detection unit and teaches the robot the first position and a second position that is different from the first position in the first round of the work and
the processor is configured to perform processing in which position control is performed on the robot based on the first position data, thereby causing the predetermined site to be situated at the first position, and processing in which position control to control the robot based on second position data about the second position acquired in the first round of the work and force control to control the robot based on an output from the force detection unit are performed, thus driving the robot and causing the predetermined site to be situated at the second position in the second round of the work.

4. The control device according to claim 1, wherein the processor is configured to detect an abnormality of the robot and detects an abnormality of the robot based on an output from the force detection unit while performing the position control.

5. The control device according to claim 1, wherein the processor is configured to perform force control on the robot based on an output from the force detection unit and cause the predetermined site to move to the first position in a predetermined round of the work.

6. The control device according to claim 1, wherein the robot has a plurality of robot arms, and
the force detection unit is provided on at least one of the plurality of robot arms.

7. A robot comprising a force detection unit and carrying out work a plurality of times,
the robot being controlled by the control device according to claim 1.

8. A robot comprising a force detection unit and carrying out work a plurality of times,
the robot being controlled by the control device according to claim 2.

9. A robot comprising a force detection unit and carrying out work a plurality of times,
the robot being controlled by the control device according to claim 3.

10. A robot comprising a force detection unit and carrying out work a plurality of times,
the robot being controlled by the control device according to claim 4.

11. A robot comprising a force detection unit and carrying out work a plurality of times,
the robot being controlled by the control device according to claim 5.

12. A robot comprising a force detection unit and carrying out work a plurality of times,
the robot being controlled by the control device according to claim 6.

13. A robot system comprising:
the control device according to claim 1; and
a robot controlled by the control device and having a force detection unit.

14. A robot system comprising:
the control device according to claim 2; and
a robot controlled by the control device and having a force detection unit.

15. A robot system comprising:
the control device according to claim 3; and
a robot controlled by the control device and having a force detection unit.

16. A robot system comprising:
the control device according to claim 4; and
a robot controlled by the control device and having a force detection unit.

17. A robot system comprising:
the control device according to claim 5; and
a robot controlled by the control device and having a force detection unit.

18. A robot system comprising:
the control device according to claim 6; and
a robot controlled by the control device and having a force detection unit.
